(19) United States
(12) Patent Application Publication
(10) Pub. No.: US 2008/0104839 A1
(43) Pub. Date: May 8, 2008

(54) Method for combining heat pipe with heat sink fin

(75) Inventors: Win-Haw Chen, Taipei (TW); Chen-Yueh Chang, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/584,530

(22) Filed: Oct. 23, 2006

(51) Int. Cl. B21D 53/02; B23P 15/26

(52) U.S. Cl. 29/890.03; 29/890.045

(57) ABSTRACT

A method for combining a heat pipe with a heat sink fin is provided, which includes the following steps: firstly, providing a heat sink fin with an opening, next, installing the heat pipe and a tin pipe into the opening, and installing the heat pipe into the tin pipe, and then, carrying out a heat treatment, so as to combine the heat pipe with the heat sink fin via the melted tin pipe.

### BACKGROUND OF THE INVENTION

1. Field of Invention

The present invention relates to a method for combining a heat pipe with a heat sink fin, and more particularly, to a method for combining a heat pipe with a heat sink fin by way of soldering.

2. Related Art

As the operational performance of a computer increases, the data processing speed for internal electronic components such as the central processing unit (CPU), the hard disk drive (HDD) is continuously enhanced, and the volume of the electronic component tends to be miniaturized, so that the density for one unit of area becomes increasingly higher, and the heat produced by electronic components increases accordingly. However, an excessively high temperature will seriously affect the stability and efficiency in terms of the operation of the computer, thus shortening the lifetime of the electronic component. Thus, heat sink devices such as a heat sink fin has become indispensable installations for a computer. The heat sink fin installed on the electronic component not only dissipates the heat produced by the electronic component quickly, but also reduces the overall temperature of the computer.

In order to deal with the increasingly enhanced heat energy of the electronic component, a heat sink device with high efficiency that applies a heat pipe to the heat sink fin is developed, which, to a great extent, eliminates the limitation of poor dissipating efficiency for the conventional heat sink fin caused by dissipating heats simply via metal conducting, thus, the heat pipe is widely used on the heat sink module. The method for combining the heat pipe with the heat sink fin in the conventional art is to dispose a through-hole on the heat sink fin, and apply a heat-conductive medium such as solder paste to the through-hole of the heat sink fin or to the heat pipe, then, insert the heat pipe into the through-hole of the heat sink fin, and finally, carry out a soldering process to combine the heat pipe with the heat sink fin.

Since the conventional solder paste is shaped like an adhesive, it is difficult for the heat pipe coated with the solder paste to penetrate the through-hole of the heat sink fin, and it is also difficult to accurately control the amount of the solder paste. Excessive solder paste will spill over the through-hole, which not only affects the appearance of the product, but also affects the heat conductive efficiency due to the pollution of impurities. Excessively small amount of solder paste will result in a poor combination effect between the heat pipe and the heat sink fin, thus, it is difficult to control the quality of the product. In view of the above, ROC Patent Publication M286920 filed on Feb. 1^{st} 2006 discloses a combination structure of a heat pipe and a heat sink fin, wherein the heat sink fin is cut into a tongue structure that is bent for an angle to form an opening for accommodating the plate-like medium material or paste-like medium material into the heat sink fin. The medium material is melted after being heated and flows between the heat pipe and the heat sink fin, thus combining the heat pipe with the heat sink fin after it is cooled and curdled.

Although the Patent M286920 can eliminate the defect of being difficult to control the amount of the solder paste, the contact area between the plate-like or paste-like medium material with the heat pipe and the heat sink fin is still quite limited, and due to the excessively small contact area, the problem of poor combining strength between the heat pipe and the heat sink fin occurs.

### SUMMARY OF THE INVENTION

In view of the above problems, the present invention provides a method for combining a heat pipe with a heat sink fin, thereby eliminating the problems of the conventional art that the solder paste is non-uniformly applied and the applying amount is difficult to control, and the combining strength is poor due to the excessively small contact area.

The method for combining a heat pipe with a heat sink fin disclosed in the present invention comprises the following steps: firstly, providing a heat sink fin with a through-opening, next, installing the heat pipe and a tin pipe into the opening, and installing the heat pipe into the tin pipe, and then, carrying out a heat treatment to the heat sink fin having the heat pipe and the tin pipe, so as to combine the heat pipe with the heat sink fin via the melted tin pipe.

The efficacy of the present invention lies in adopting the tin pipe as the medium between the heat pipe and the heat sink fin, so that the heat pipe and the heat sink fin are closely combined with each other at a maximum contact area, therefore, it is not only easy to control the amount of the medium material for combining and the process is simplified, but the combining strength between the heat pipe and the heat sink fin is also enhanced and the overall heat sink efficiency is improved.

The above illustration of the present invention and the following detailed description are given for demonstrating and illustrating the principle of the present invention and providing a further illustration of the claims.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a flow chart of steps of a first embodiment of the present invention;

FIG. 2A is an exploded view of the steps of the first embodiment of the present invention;

FIG. 2B is an exploded view of the steps of the first embodiment of the present invention;

FIG. 2C is an exploded view of the steps of the first embodiment of the present invention;

FIG. 2D is an exploded view of the steps of the first embodiment of the present invention;

FIG. 2E is an exploded view of the steps of the first embodiment of the present invention;

FIG. 3 is a flow chart of steps of a second embodiment of the present invention;

FIG. 4A is an exploded view of the steps of the second embodiment of the present invention;

FIG. 4B is an exploded view of the steps of the second embodiment of the present invention;

FIG. 4C is an exploded view of the steps of the second embodiment of the present invention; and

FIG. 4D is an exploded view of the steps of the second embodiment of the present invention.

### DETAILED DESCRIPTION OF THE INVENTION

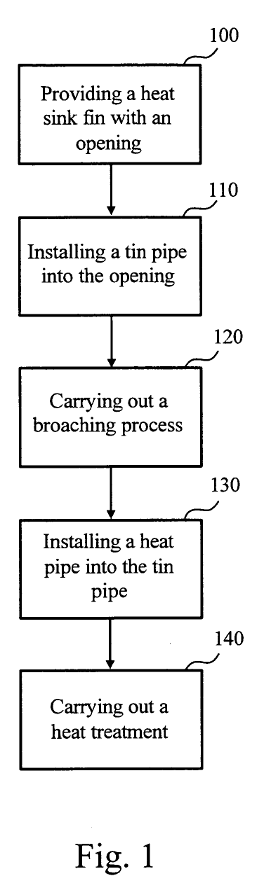

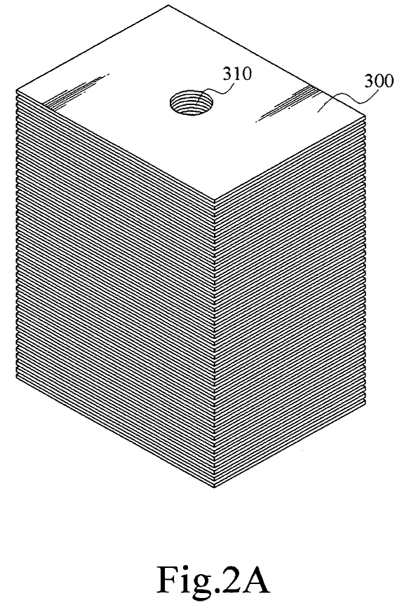

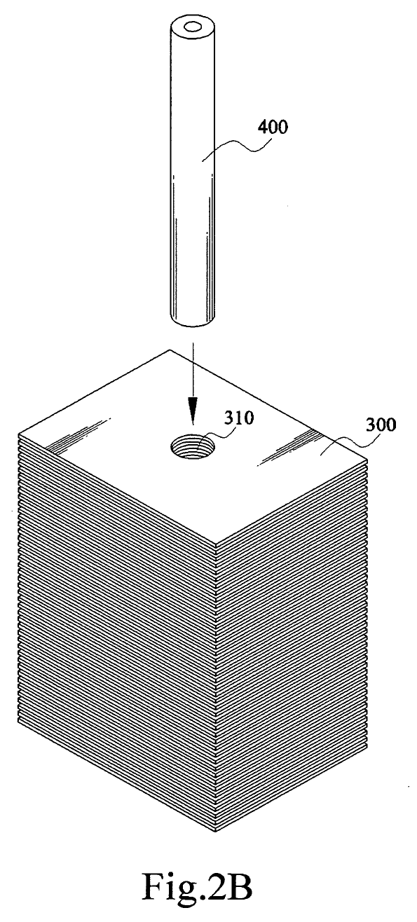

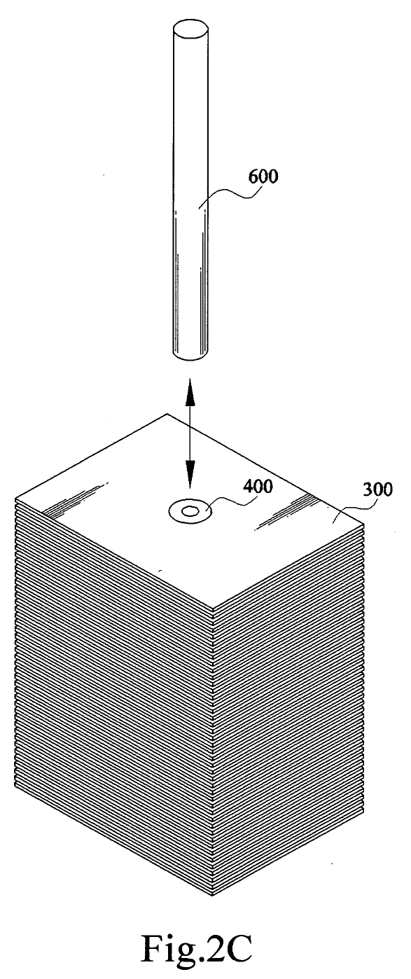

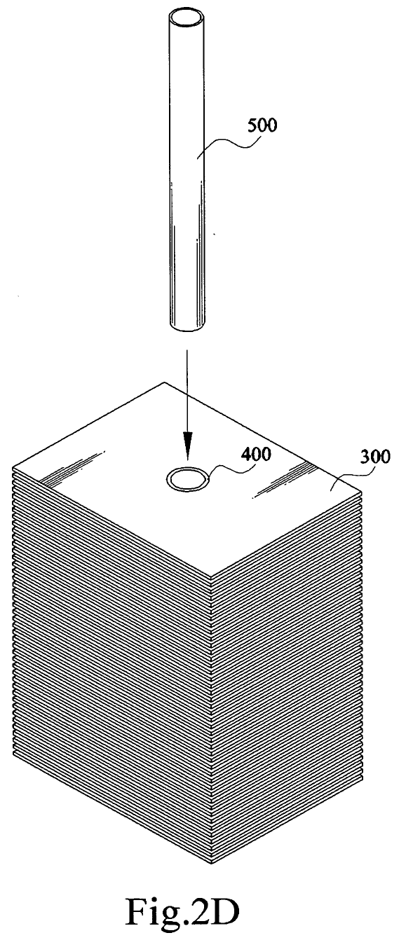

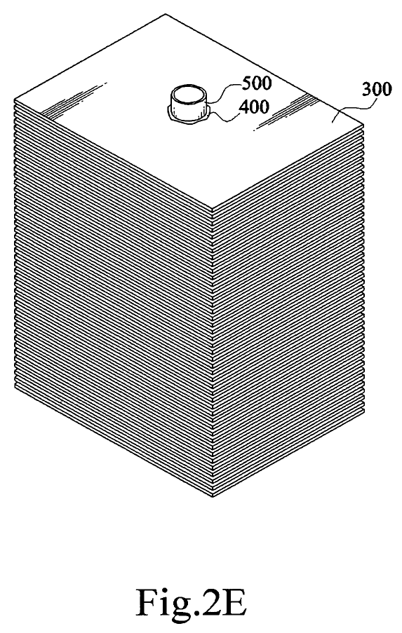

FIG. 1 and FIGS. 2A to 2E are a flow chart and a schematic stereogram of steps of a first embodiment of the present invention. As shown in figures, the method for combining a heat pipe 500 with a heat sink fin 300 includes the following steps: firstly, providing a heat sink fin 300 (Step 100), which has an opening 310 penetrating there-through in the axial direction at one end, next, installing a tin pipe 400 in the opening 310 (Step 110), and carrying out a tin pipe broaching process to the tin pipe 400 installed in the heat sink fin 300 (Step 120), which is achieved by inserting a broaching member 600 into the opening 310 having the tin pipe 400, and expanding the opening 310 to an original size, wherein the hardness of the material of the broaching member 600 is higher than that of the tin pipe 400, so as to press the tin pipe 400 to deform into the same size as the outer diameter of the broaching member 600 during the broaching process. Then, installing a heat pipe 500 into the tin pipe 400 (Step 130), wherein the outer diameter of the heat pipe 500 is consistent with the inner diameter of the opening 310, so that the heat pipe 500 is tightly installed and accommodated within the tin pipe 400, then, carrying out a heat treatment to the heat sink fin 300 having the tin pipe 400 and the heat pipe 500 (Step 140), so as to melt the tin pipe 400 between the heat pipe 500 and the heat sink fin 300, and thereby combining the heat pipe 500 with the heat sink fin 300 at a maximum contact area via the uniformly melted tin pipe 400.

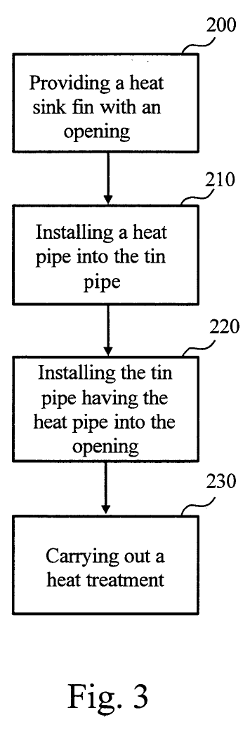

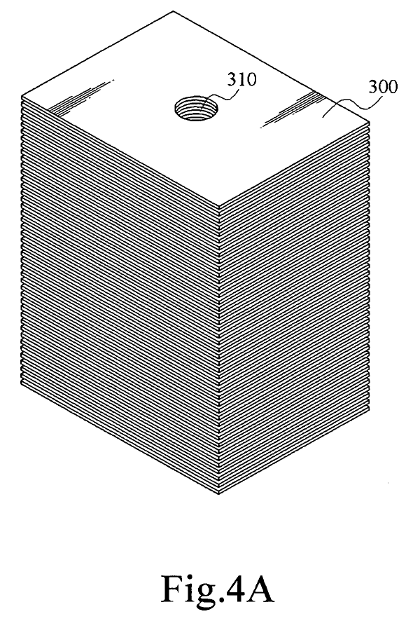

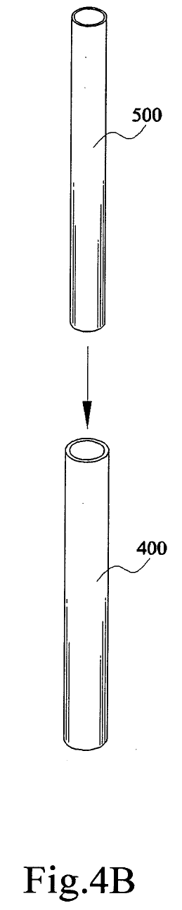

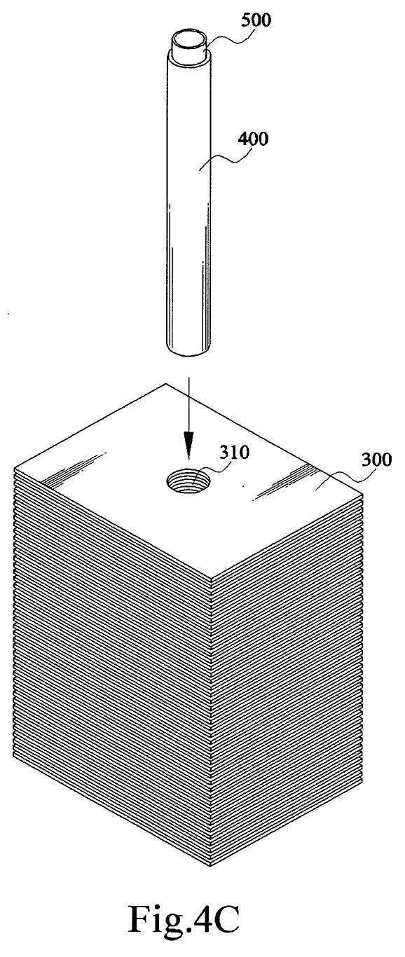

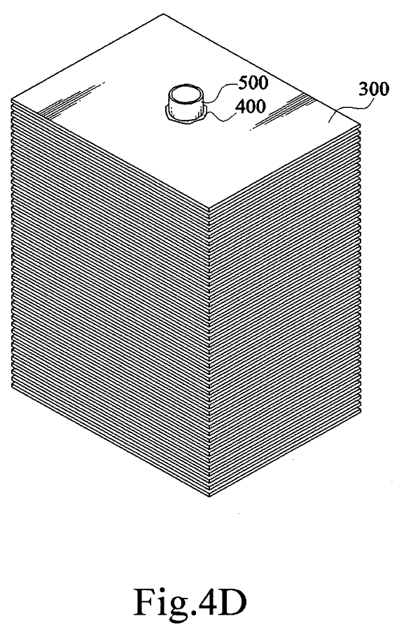

FIG. 3 and FIGS. 4A to 4D are a flow chart and a schematic stereogram of steps of a second embodiment of the present invention. As shown in figures, providing a heat sink fin 300 (Step 200) firstly, which has an opening 310 penetrating there-through in the axial direction at one end, next, installing a heat pipe 500 into a tin pipe 400 (Step 210), and the heat pipe 500 is fixed in the hollow structure of the tin pipe 400 via tight fit manner. Then, installing the tin pipe 400 having the heat pipe 500 into the opening 310 (Step 220), and the inner diameter of the opening 310 is consistent with the outer diameter of the tin pipe 400, so that the tin pipe 400 and the heat pipe 500 are closely contacted the inner wall of the opening 310 without a gap when being installed into the opening 310. Finally, carrying out a heat treatment (Step 230), so as to melt the tin pipe 400 between the heat pipe 500 and the heat sink fin 300, and thereby combining the heat pipe 500 with the heat sink fin 300 at a maximum contact area via the uniformly melted tin pipe 400.

A soldering flux can be further added into the tin pipe 400 that serves as the medium, thereby further enhancing the combining strength between the heat pipe 500 and the heat sink fin 300. Furthermore, in order to protect the operator from being hurt by the lead-alloy solder that is volatilized under a high temperature or the dust produced during the process, the tin pipe 400 disclosed in the present invention is made of lead-free solder, so as to meet the operation safety requirements, which is now highly emphasized in each country all over the world.

Compared with the conventional art, the present invention adopts the tin pipe as the medium between the heat pipe and the heat sink fin, thus the heat pipe and the heat sink fin are combined at a maximum contact area, therefore, it is not only easy to control the applying amount of the medium and the process is simplified, but the combining strength and the dissipating efficiency are also greatly enhanced, due to the large contact area between the heat pipe and the heat sink fin.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for combining a heat pipe with a heat sink fin, comprising:
providing a heat sink fin having a through-opening;
installing a tin pipe into said opening;
installing a heat pipe into said tin pipe; and
carrying on a heat treatment, for melting said tin pipe and thereby combining said heat pipe with said heat sink fin.

2. The method for combining a heat pipe with a heat sink fin as claimed in claim 1, further comprising a step of carrying out a tin pipe broaching process after the step of installing said tin pipe into said opening.

3. A method for combining a heat pipe with a heat sink fin, comprising:
providing a heat sink fin having a through-opening;
installing a heat pipe into a tin pipe;
installing said tin pipe having said heat pipe into said opening; and
carrying out a heat treatment, for melting said tin pipe and thereby combining said heat pipe with said heat sink fin.
